(19) United States
(12) Patent Application Publication
(10) Pub. No.: US 2004/0139830 A1
(43) Pub. Date: Jul. 22, 2004

(54) Article of manufacture for securing a covering to a surface

(76) Inventors: James Don Knox, Tulsa, OK (US); Matthew Jay Sampson, Tulsa, OK (US)

Correspondence Address: James Don Knox, 1303 S. Euanston Ave, Tulsa, OK, 74104, US

(21) Appl. No.: 10/347,856

(22) Filed: Jan. 21, 2003

(51) Int. Cl. B25B 1/00

(52) U.S. Cl. 81/488

(57) ABSTRACT

An article of manufacture for securing a floor covering to a floor with a thin flat piece of metal which slides underneath floor base board trim, and a rounded solid resin piece attached to the metal. The thin flat piece secures the article to the wall by wedging itself between the base board trim and the floor. The resin piece provides pressure to hold the floor covering in place through the metals shape memory. The floor covering is then secured to the floor by inserting the floor covering between the resin piece and the floor. The thin metal piece may be constructed from any other material which will provide the same clamping action. The resin piece may be constructed from any material which provides sufficient hold on the floor covering. The device may also be constructed with a hinge and spring where the spring provides the clamping force.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of home remodeling and more specifically to an article of manufacture for securing a covering to a surface. Floor covering or drop cloths are often used when painting or repairing walls or ceilings. A good method to hold the covering or drop cloth in place is needed. The method outlined in this application is for a thin strip of metal to be wedged underneath the floor board molding. At the end of the metal strip is a molded resin ball. The floor covering of drop cloth is placed underneath the resin ball and is held in place by the spring action (shape memory) from the metal strip.

In the past the floor covering was held in place by securing the edges of the floor covering with tape.

Securing the floor covering with tape has its problems. It is time consuming to tape all edges of the covering and the tape often looses its adhesion to the baseboard. Since the tape applies a minimal force to the floor covering, the floor covering is easily pulled away from the wall.

### BRIEF SUMMARY OF THE INVENTION

The primary object of the invention is to provide a floor covering clamp that can easily be installed and removed.

Another object of the invention is to eliminate the use of tape on base boards while painting.

Another object of the invention is to allow one person to easily spread a drop cloth by attaching on end of the drop cloth to the floor at one wall and spreading the drop cloth to the far wall and adjacent walls.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for securing a covering to a surface comprising: a thin flat piece of metal which slides underneath floor base board trim, and a rounded solid resin piece to hold the floor covering in place.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

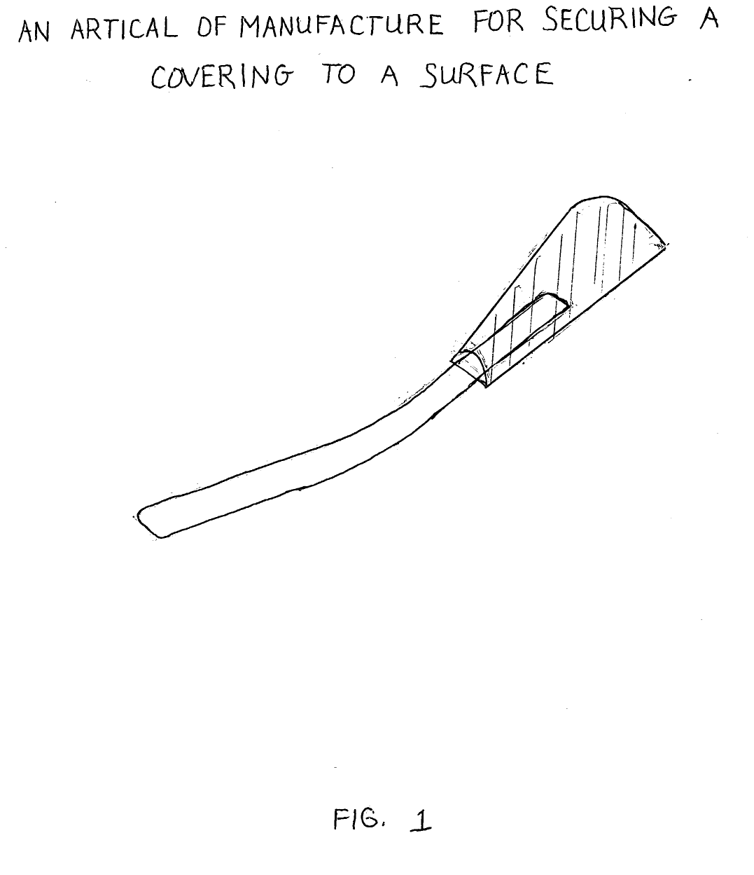

FIG. 2 is a plan view of the invention.

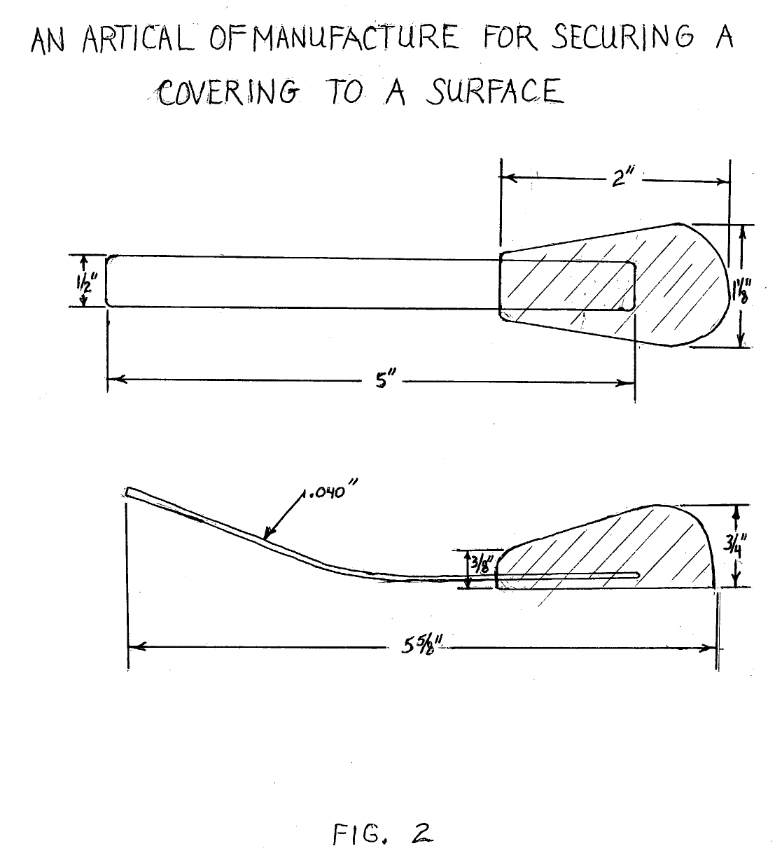

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The tarp clip is an article of manufacture for securing a covering to a surface comprising: a thin flat piece of metal which slides underneath floor board trim; and a rounded solid resin piece to hold the floor covering in place. The metal piece is 301 half hard steel 5″ by ½″ of 40/1000 thickness, and the ball is comprised of casting resin. Approximately 4″ of metal extending from the ball.

The purpose of the clip is to provide a new and better method for securing a floor covering to the floor and up against the wall to prevent paint from getting on the floor during painting of walls and ceilings. By using clips that can easily be installed and removed the need for tape or heavy items to hold the covering in place is eliminated. The clip also provides assistance when unfolding the floor covering by holding the corner of covering in place allowing one person to unfold the covering with ease. By using a thin metal strip of 301 half hard steel the user is also able to modify the shape for use on wood floors or carpeted floors.

The floor clip works by sliding the metal end under the base board and wall. The metal strip is curved and must be straightened to slide under the base board. Pressure to clamp the covering to the floor is provided by the metals shape memory working though the resin ball and applying a clamping force to the floor. The floor covering is then placed between the resin ball and the floor. The metal can be formed to increase or decrease pressure for applications on wood or carpeted flooring.

Other clip designs could make use of a spring and hinge to apply the clamping force. The resin ball could be manufactured of any material or shape that provided adequate grip to the floor covering such as plastic. The metal strip could be made of any formable material that has a spring action in order to provide the clamping force. The purpose of the tarp clip is to provide an easy method of holding a floor covering in place during painting or working on walls and ceilings.

Metal memory (shape memory): The tendency of a metal or other material to try to return to its original shape when a force is applied.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for securing a covering to a surface comprising:
a thin flat piece of metal which slides underneath floor base board trim; and
a rounded solid resin piece to hold the floor covering in place.

2. The article of manufacture from claim 1 wherein the metallic piece is manufactured from plastic.

3. The article of manufacture from claim 1 wherein the rounded resin piece is made in another shape.

4. The article of manufacture from claim 1 wherein the rounded resin piece is made from a material other than resin.

5. The article of manufacture from claim 1 wherein the clip is designed using a hinge and spring in which the spring provided the clamping force.
